(19) United States
(12) Patent Application Publication
(10) Pub. No.: US 2018/0290874 A1
(43) Pub. Date: Oct. 11, 2018

(54) Validation system for smart dispensing

(71) Applicant: Warner B. Roberts, Copley, OH (US)

(72) Inventor: Warner B. Roberts, Copley, OH (US)

(21) Appl. No.: 15/941,824

(22) Filed: Mar. 30, 2018

Related U.S. Application Data
(60) Provisional application No. 62/482,323, filed on Apr. 6, 2017.

(51) Int. Cl. B67D 1/12; G07F 13/06

(52) U.S. Cl. CPC B67D 1/1236; B67D 2001/0811; G07F 13/065

(57) ABSTRACT

A means and method to validate that a product is properly dispensed based on price paid for a size, class or type of product. Other functions of this system may include linking information such as but not limited to demographic information with product and class that was selected and stored in provider's customer database or other databases for purpose of monitoring consumer choice of product or class by demographic category by visit.

### CROSS-REFERENCE TO RELATED APPLICATIONS

This application claims priority to U.S. Provisional patent application No. 62/482,323 which was filed on Apr. 6, 2017

### STATEMENT REGARDING FEDERALLY SPONSORED RESEARCH OR DEVELOPMENT

NA

### REFERENCE TO A “MICROFICHE APPENDIX”

NA

### BACKGROUND OF THE INVENTION

### (1) Field of the Invention

A means and method for validating purchases, more specifically a means and method for validating a purchase of a product or class of product has been made before dispensing of product is allowed.

### (2) Description of the Related Art

More operations are becoming self-service, where a customer pays for a product and then receives a product through a method of dispensing, dispersing or vending that is by the action of the customer. Several technologies have been developed to help facilitate this change. Most technologies developed were for various methods that after a purchase, validates that a sale was made for a certain product and dispensing of a certain product is allowed. They may also involve the use of a using specific container. The methods used to initiate an action include imbedded radio frequency identification transponders that may be using specific containers manufactured for that specific application, radio frequency identification transponders that are applied externally to containers and may be using specific containers manufactured for that specific application, are for other specific methods of printing electronically responsive codes or indicia that may be using specific containers manufactured for that specific application, and or on things such as wrist bands. Some methods of recognizing that an action is to take place and initiating that action include the specialized readers for the specific technology and the motion of the container which then allows for the reading of the instructions of the actions that are to proceed. Most of these technologies are specific to limiting the dispensing of a certain product to a specific selection that is retained in a system based on some specific criteria such as a preferred formula or recipe previously selected or it might be selected for the first time and then that selection of formula is retained in the system for future usage. When other technologies are used like QR codes or barcodes, they too have been limited to a number of options including a fixed customized selection, to access the system in order to make changes to the customized and stored information, for the ability to make a user's selection available to share on that user's social media and linking to a website for various information or for leaving customer reviews on the website. Other operations that may use a printed code include first defining if the product ingredients are available to be mixed or blended before the operation proceeds and then dispensing.

### BRIEF DESCRIPTION OF THE DRAWINGS

A means and method embodying the invention are hereinafter described, by way of example, referenced to the accompanying drawing.

FIG. 1 shows a view providing substantially at least the elements from claim 1

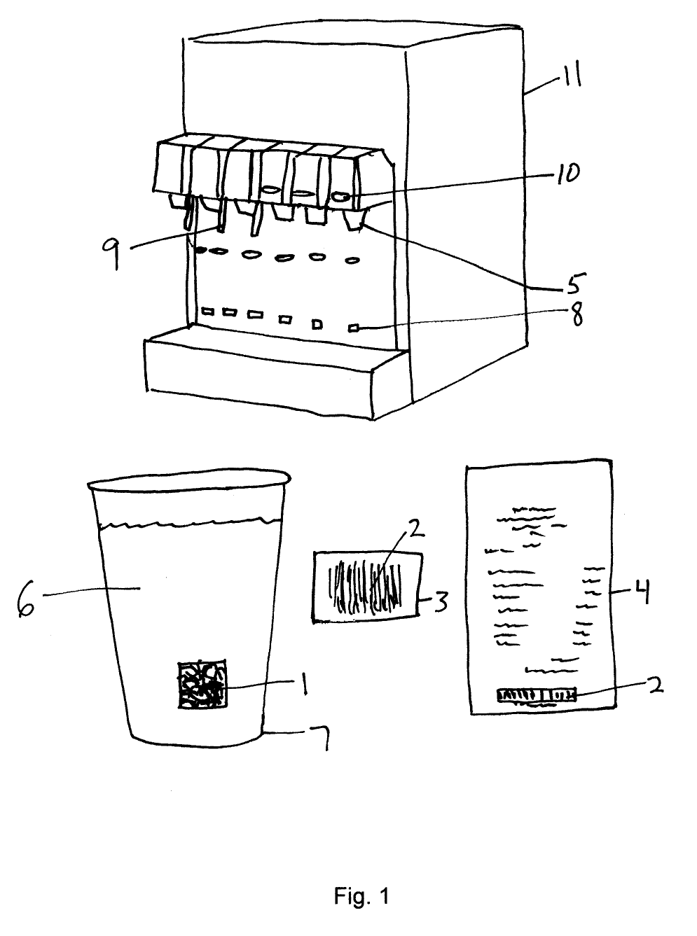

### DETAILED DESCRIPTION

I recognized that there were other needs that technology could facilitate and that a specific need may only require certain aspects and technologies and they would be an advantage. The present invention meets an unmet need in the market by introducing validation of payment for a product at a price, of class or category and approval to dispense based on that product's price, class or category. Products may have a multitude of price points based on size, volume, class, or category and it may be necessary to validate the item to be dispensed is for what was paid for or of equal or lesser value. With this means and method, a sale or purchase is associated to any container that reflects the size paid for or may be brought by the purchaser and then dispensing of an appropriate product is allowed. This may be for a specific purchase, may be for a specified limited time, may be but not limited to one visit or a one-time purchase. It may also be limited to one product within the purchased category, to all products within the category or all lesser categories when a higher category is purchased.

### First Embodiment

In this embodiment, a QR Code 1 sticker 3, barcode 2 sticker 3 or a portion of a receipt 4 is printed when a product 6 is paid for. A container 7 with sticker 3 with codes 1 or 2 applied or receipt 4 with code 1 or 2 printed on it is displayed before a reader 8 which may be under a dispensing port 5 of a dispenser 11, a separate implement such as part of a payment system or appropriate point on a vending machine to read the appropriate code 1 or 2. Once the code 1 or 2 is verified and confirmed to customer by what might be a light 12, it allows for the dispensing of the product 6 paid for or of equal or lesser value. In cases of multiple products being purchased, the appropriate number and coded stickers 3 or codes on the receipt is generated.

To operate this system, the point at which the product 6 is paid for may be separate from where the dispenser 11 is located. The customer orders a product 6 or products 6 among a list provided of types and categories. Customer then pays and an appropriate QR Code 1 or barcode 2 is generated as a sticker 3 or as part of the receipt 4. Customer takes container 7 places sticker 3 in appropriate area or it may be part of the receipt 4 which a part or whole may or may not be placed on container 7. Customer then proceeds to dispenser 11 or vending. A QR Code 1 or barcode 2 reader 8 is positioned in such a way that the QR code 1 or barcode 2 on container 7 or receipt 4 can be read by reader 8.

The customer then uses the QR Code 1 or barcode 2 at dispenser 11, payment point, vending machine or any of a number of potential options a reader could be placed to activate the method of dispersing product that was paid for. In this example, the QR Code 1 or barcode 2 is for a Premium product 6. Since a customer has paid for a premium product 6, it could also be used to dispense a standard product 6 and can be used for either class for refills. This example also facilitates transactions where a “bring your own” container 7 is employed, and the operation is the same but with the substitution of the BYOC container 7 for a disposable one that would have been purchased for the transaction. In instances of more than one customer on a transaction, the appropriate number of stickers 3 or lines of code on receipt with the classification of product 6 would be printed for proper dispensing. The customer places the container 7 or receipt 4 in the appropriate position, is given a response that the code 1 or 2 has been accepted, by what may be a light 12. The customer then utilizes the method to commence the flow of product 6 such as a lever 9 or button 10 or other form of activation. Once the product 6 reaches an appropriate amount, lever 9 or button 10 or other form of activation is released to cease flow and the container 7 is withdrawn from under port 5. In example of multiple customers, each succeeding dispense would require a separate sticker 3 or scan of the distinct codes 1 or 2 on receipt 4. The codes may be modified as needed to denote a specified amount of time to limit the transaction to a time frame, so it is not re-used on successive visits or for extended periods during the one visit.

The robustness of QR Codes 1 and barcodes 2 may expand the scope of uses so they may include linking demographic information from a customer loyalty card program to the purchase of the specific selection of what is dispensed. This would print as part of the code an identifier linking it to a customer's affinity card 13 unique identification number that would then link the purchase to the demographic information fields specified, but not the specific identity of the affinity card 13 holder. So, when scanned it captures all the data specified and this information could be stored within a provider's customer database or other database for the purpose of monitoring consumers' choices of product 6 by class by demographic group and not to a specific customer.

### Second Embodiment

In the second embodiment, a QR code 1 or barcode 2 would be sent to a customer's handheld device 11 such as but not limited to a mobile phone, to perform all the same operations listed in embodiment 1 but replace the use of printed codes 1 or 2 with codes 1 or 2 that are sent in an electronic format, either as a physical code shown on the handheld screen or as a signal such as used with Near-field communication technology.

To operate the system, the point at which the product 6 is paid for may be separate from where the dispenser 11 is located. The customer orders a product 6 or products 6 among a list provided of types and categories. Customer then pays and an appropriate QR Code 1 or barcode 2 is generated in an electronic format or as an Near-field communication identifier and they may be sent as an email, text, or to the customer's account app and the operation from that point on is generally the same as in embodiment 1 with the exception that the electronic format replaces the printed codes 1 or 2 to verify an appropriate payment for a product 6 has been made. The codes may be modified as needed to denote a specified amount of time, to limit the transaction to a time frame so it is not re-used on successive visits. It may as well include linking demographic information from a customer loyalty card program to the purchase of the specific selection of what is dispensed. This would print as part of the code an identifier linking it to a customer's affinity card 13 unique identification number that would then link the purchase to the demographic information fields specified, but not the specific identity of the affinity card 13 holder. So, when scanned it captures all of the data specified and this information could be stored within a provider's customer database or other database for the purpose of monitoring consumers' choices of product 6 by class, by demographic group and not to a specific customer.

### Third Embodiment

In the third embodiment, a QR code 1 or barcode 2 is pre-printed on container 12 to perform all the same operations listed in embodiment 1 but replace the use of printed codes 1 or 2 on stickers 3 or receipt 4 by codes 1 or 2 pre-printed on container or package 7.

To operate this system, the point at which the product 6 is paid for is separate from where the dispenser 11 is located. The customer orders a product 6 or products 6 among a list provided of types and categories. Customer then pays and an appropriate pre-printed-container(s) or package(s) 7 is given and the operation from that point on is generally the same as in embodiment 1 with the exception that the pre-printed container 7 replaces the stickers 3 and receipt 4 that have codes. It may include linking some demographic information from a customer loyalty card program to the purchase of the specific selection of category of product but not to a specific product. This would be accomplished by customer's affinity card 13 unique identification number being linked to the purchase of a category and then linked to the demographic information fields specified, but not the specific identity of the affinity card 13 holder. This information could be stored within a provider's customer database or other database for the purpose of monitoring consumers' choices of product 6 class, by demographic group and not to a specific customer.

### Fourth Embodiment

In the fourth embodiment, affinity card 13 with a QR code 1 or barcode 2 is pre-printed on it to perform all the same operations listed in embodiment 1 but replace the use of printed codes 1 or 2 on stickers 3 or receipt 4 by codes 1 or 2 pre-printed on affinity card 13.

To operate this system, the point at which the product 6 is paid may be separate from where the dispenser 11 is located. The customer orders a product 6 or products 6 among a list provided of types and categories. Customer then pays and gives the affinity card 13 which then is associated with that transaction. The operation from that point on is generally the same as in embodiment 1 with the exception that the pre-printed affinity card 13 replaces the printed codes 1 and 2. The codes may modified internally as needed to denote a transaction is verified for that date, for a specified amount of time to limit the transaction to a time frame so it is not re-used on successive visits unless the product and category is paid for. The connection to a demographic group is made within the system and would have to change on the card, but the system would track a transaction based on date and time for approval.

Although several embodiments of the invention have been described, it will be understood that those skilled in the art, both now in the future, may make various improvements and enhancements that fall within the scope of claims that follow and the equivalents thereof. Moreover, although the invention has been described in the particular application of a beverage dispenser, it should be understood that the invention may be used in various other applications such as the vending of a product from what may be but not limited to a vending machine for solid versus liquid products or as part of a more comprehensive autonomous system. These claims should be construed to maintain the proper protection for the invention first described.

What is claimed is:

1. A means and method that may utilize systems that may include but not be limited to QR Codes, Barcodes, and Near-field communication with an appropriate reader for the technology of same as a method of validating payment for a product or class of product before a dispensing method may activate a dispensing cycle for product based on a price or a classification of product purchased that differentiates it from other uses of codes used for detecting what has been paid for a product or other uses of such means and method.

2. Said means may be an improvement as it may dispense but is not be limited to such things as liquid products, solid products or containers for either product.

3. Said means may be an improvement as it may allow for dispensing of more than one product class based on price paid so that if product of a higher value is paid for one of lower value may be dispensed based on having paid for said higher value class of product.
a. This may facilitate alternate choices within or between categories based on price paid and where payment for product may allow for customer to dispense more than one time per visit.

4. Said means may be an improvement as it may not be limited to, a code in a printed format, electronic format, on an affinity card or other type of means to validate a purchase.

5. Said means may an improvement as it may generate a new code or other means on a schedule or other option to be determined by a provider of product that is to be purchased and dispensed, so provider may limit the time frame dispensing of product may be allowed.

6. Said means may be an improvement as it may also link but not limited to demographic information that is not identifiable as the customer, from information fields such as but not limited to demographic profiles provided from but not limited to those of an affinity card program and where field or fields may be made part of a code and printed as part of or be a part of what may be the initiating code that may be transmitted by other means but not limited to a QR code, barcode or electronically, that is then linked with the information as to the variables of customer selection such as but not limited the exact product or product dispensed and may then be retained in a system data base of what may have been transacted on a visit or visits by customers by what might be but not limited to demographic categories.
